(19) United States
(12) Patent Application Publication
(10) Pub. No.: US 2013/0324140 A1
(43) Pub. Date: Dec. 5, 2013

(54) APPARATUS AND METHOD FOR TRANSMITTING CHANNEL STATE INFORMATION IN WIRELESS COMMUNICATION SYSTEM

(71) Applicants: Ki Bum Kwon, Seoul (KR); Kung Min Park, Seoul (KR)

(72) Inventors: Ki Bum Kwon, Seoul (KR); Kung Min Park, Seoul (KR)

(73) Assignee: PANTECH CO., LTD., Seoul (KR)

(21) Appl. No.: 13/984,970

(22) PCT Filed: Feb. 16, 2012
(86) PCT No.: PCT/KR2012/001176

§ 371 Date: Aug. 12, 2013

(30) Foreign Application Priority Data
Feb. 16, 2011 (KR) 10-2011-0013851

(51) Int. Cl. H04L 5/00

(52) U.S. Cl. CPC H04L 5/0057
USPC 455/450

(57) ABSTRACT

The present invention relates to an apparatus and method for transmitting channel state information in a wireless communication system. This specification discloses a UE including: a reception unit for receiving coordination mode activation information indicating an ICIC mode to restrict a measurement of a channel state, and receiving CSI request information requesting aperiodic transmission of the CSI, a UE configuration control unit for switching a state of the UE to the ICIC mode based on the coordination mode activation information and for configuring one or more serving cells in the UE, a measurement unit for measuring a channel state for a subset in an activated serving cell from among the configured one or more serving cells based on the CSI request information, an information generation unit for generating CSI regarding the measured channel state, and a transmission unit for transmitting the generated CSI to the BS.

### CROSS-REFERENCE TO RELATED APPLICATIONS

This application is the National Stage Entry of International Application PCT/KR2012/001176, filed on Feb. 16, 2012, and claims priority from and the benefit of Korean Patent Application No. 10-2011-0013851, filed on Feb. 16, 2011, both of which are incorporated herein by reference in their entireties for all purposes as if fully set forth herein.

### BACKGROUND

1. Field

The present invention relates to wireless communication and, more particularly, to an apparatus and method for transmitting channel state information in a wireless communication system.

2. Discussion of the Background

3^{rd} Generation Partnership Project (3GPP) Long Term Evolution (LTE) that is the improvement of a Universal Mobile Telecommunications System (UMTS) is introduced as 3GPP release 8. The 3GPP LTE uses Orthogonal Frequency Division Multiple Access (OFDMA) in downlink and uses Single Carrier-Frequency Division Multiple Access (SC-FDMA) in uplink. The 3GPP LTE adopts Multiple Input Multiple Output (MIMO) having a maximum of 4 antennas. A discussion on 3GPP LTE-Advanced (LTE-A) that is the evolution of the 3GPP LTE is recently in progress.

With the development of wireless communication technology, a heterogeneous network environment comes to the front. In the heterogeneous network environment, a macro cell, a femto cell, a pico cell, etc. are used. Each of the femto cell and the pico cell, as compared to the macro cell, is a system that covers an area smaller than the existing mobile communication service radius. In this communication system, a user terminal existing in any one of the macro cell, the femto cell, and the pico cell experiences inter-cell interference caused by signal interference due to signals generated from other cells.

### SUMMARY

An object of the present invention is to provide an apparatus and method for transmitting channel state information in a wireless communication system.

Another object of the present invention is to provide an apparatus and method for transmitting channel state information of a cell set and each subset.

Yet another object of the present invention is to provide an apparatus and method for performing limited channel state measurement or report.

Further yet another object of the present invention is to provide an apparatus and method for triggering a report on channel state information about an activated serving cell.

Still yet another object of the present invention is to provide a method in which a user equipment operated in an inter-cell interference coordination mode transmits channel state information.

According to an embodiment of the present invention, a user equipment (UE) transmitting Channel State Information (CSI) in a wireless communication system is provided. The UE includes: a reception unit configured for receiving coordination mode activation information indicating an Inter-Cell Interference Coordination (ICIC) mode to restrict a measurement of a channel state, and configured for receiving CSI request information requesting aperiodic transmission of the CSI, from a base station (BS), a UE configuration control unit configured for switching a state of the UE to the ICIC mode based on the coordination mode activation information and configured for configuring one or more serving cells in the UE, a measurement unit configured for measuring a channel state for a subset in an activated serving cell from among the configured one or more serving cells based on the CSI request information, the subset being a set of one or more subframes, an information generation unit configured for generating CSI regarding the measured channel state, and a transmission unit configured for transmitting the generated CSI to the BS.

According to another embodiment of the present invention, a method of a user equipment (UE) transmitting Channel State Information (CSI) in a wireless communication system is provided. The method includes: receiving coordination mode activation information indicating an Inter-Cell Interference Coordination (ICIC) mode to restrict a measurement of a channel state, from a base station (BS), switching the UE to the ICIC mode based on the coordination mode activation information, receiving CSI request information requesting aperiodic transmission of the CSI, from the BS, measuring, based on the CSI request information, a channel state for a subset in an activated serving cell, from among one or more serving cells configured in the UE, the subset being a set of one or more subframes, and transmitting the CSI regarding the measured channel state to the BS.

According to yet another embodiment of the present invention, a base station (BS) receiving Channel State Information (CSI) in a wireless communication system is provided. |The BS includes: a transmission unit configured for transmitting coordination mode activation information indicating an Inter-Cell Interference Coordination (ICIC) mode to restrict a measurement of a channel state and configured for transmitting CSI request information requesting aperiodic transmission of the CSI to a user equipment (UE), a reception unit configured for receiving the CSI based on the CSI request information, from the UE, and a scheduling unit configured for performing downlink scheduling for the UE based on the CSI.

The CSI request information may instruct to trigger a report on a channel state restricted by the ICIC mode.

According to still yet another embodiment of the present invention, a method of a base station (BS) receiving Channel State Information (CSI) in a wireless communication system is provided. The method includes: transmitting coordination mode activation information, indicating Inter-Cell Interference Coordination (ICIC) mode to restrict a measurement of a channel state, to a user equipment (UE), transmitting CSI request information, requesting aperiodic transmission of the CSI, to the UE, receiving the CSI based on the CSI request information, from the UE, and performing downlink scheduling for the UE based on the CSI.

The CSI request information may instruct to trigger a report on a channel state restricted by the ICIC mode.

If various forms of cells, such as a macro cell, a micro cell, a pico cell, and a femto cell, exist and a TDM scheme is used to control interference occurring between the cells, CSI varying according to the time can be measured more precisely and CSI at a time point desired by a scheduler can be secured in accordance with the TDM scheme. Accordingly, a scheduling gain for the resource allocating of a serving cell can be improved.

### BRIEF DESCRIPTION OF THE DRAWINGS

FIG. 1 is a diagram schematically illustrating the concept of a heterogeneous network composed of a macro cell, a femto cell, and a pico cell.

FIG. 2 is a diagram schematically illustrating that a UE is influenced by interference between a macro cell, a femto cell, and a pico cell in downlink.

FIG. 3 is a diagram showing a frame pattern for ICIC in a heterogeneous network system.

FIG. 4 is an explanatory diagram illustrating the concept of a Primary Serving Cell and a Secondary Serving Cell.

FIG. 5a is a flowchart illustrating a method of transmitting CSI according to an embodiment of the present invention.

FIG. 5b is a flowchart illustrating a method of transmitting CSI according to another embodiment of the present invention.

FIG. 6 is a flowchart illustrating a method of transmitting CSI according to yet another embodiment of the present invention.

FIG. 7 is a flowchart illustrating a method of a UE transmitting CSI according to an embodiment of the present invention.

FIG. 8 is a flowchart illustrating a method of a BS receiving CSI according to an embodiment of the present invention.

FIG. 9 is a block diagram showing a UE and a BS according to an embodiment of the present invention.

### DETAILED DESCRIPTION OF THE ILLUSTRATED EMBODIMENTS

Hereinafter, in this specification, the contents related to the present invention will be described in detail in connection with exemplary embodiments with reference to the accompanying drawings. It is to be noted that in assigning reference numerals to respective elements in the drawings, the same reference numerals designate the same elements throughout the drawings although the elements are shown in different drawings. Furthermore, in describing the embodiments of the present invention, a detailed description of the known functions and constructions will be omitted if it is deemed to make the gist of the present invention unnecessarily vague.

In this specification, a wireless communication network is chiefly described as the subject. Tasks performed in the communication network may be performed in a process in which a system (e.g., a base station) managing the wireless communication network controls the wireless communication network and sends data or may be performed in a user equipment connected to the wireless communication network.

In a heterogeneous network in which heterogeneous cells exist in the same space, it is necessary to coordinate interference between the heterogeneous cells along with scheduling for a user equipment.

It is difficult to satisfy a demand for increasing data service by simply dividing cells into macro cells and micro cells. To solve this problem, data service may be provided to indoor and outdoor small-sized areas by using a pico cell, a femto cell, a wireless relay, etc. Although the small-sized cells are not limited to specific purposes, the pico cell may be chiefly used in a communication shadow area not covered by only the macro cell or an area requiring a lot of data service (so called a hot zone). The femto cell may be chiefly used in indoor offices or homes. Furthermore, the wireless relay may supplement the coverage of the macro cell.

If a heterogeneous network is configured, the shadow area of data service can be obviated and the data transfer rate can also be increased.

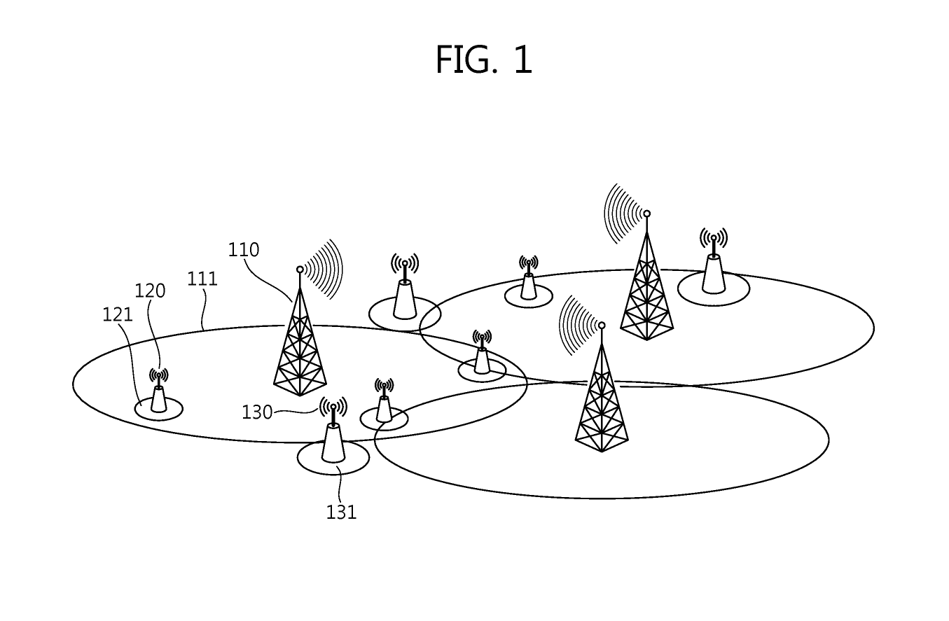

FIG. 1 is a diagram schematically illustrating the concept of a heterogeneous network composed of a macro cell, a femto cell, and a pico cell.

Referring to FIG. 1, a macro Base Station (hereinafter referred to as a ‘BS’) 110, a femto BS 120, and a pico BS 130 are operated in the heterogeneous network. The macro BS 110, the femto BS 120, and the pico BS 130 have respective cell coverages 111, 121, and 131. A cell provided by the macro BS 110 is called a macro cell 111, a cell provided by the femto BS 120 is called a femto cell 121, and a cell provided by the pico BS 130 is called a pico cell 131.

The femto BS 120 is a low-power wireless access point and is a BS for ultra small-sized mobile communication which is used in the interior of a room, such as a home or an office. The femto BS 120 may access a mobile communication core network by using a DSL, a cable broadband, etc. of a home or an office. The femto BS 120 is connected to a mobile communication network over a wired network, such as an Internet network. A User Equipment (hereinafter referred to as an ‘UE’) within the femto cell may access the mobile communication core network or the Internet network through the femto BS.

The femto BS 120 supports a self-organization function. The self-organization function is classified into a self-configuration function, a self-optimization function, a self-monitoring function, etc. The self-configuration function is a function that enables the femto BS itself to install a wireless BS on the basis of an initial installation profile without experiencing a cell planning step. The self-optimization function is a function of optimizing a list of neighbor BSs by identifying neighboring BSs and obtaining pieces of information from the BSs and of optimizing coverage and communication capacity according to a change of subscribers and traffic. The self-monitoring function is a function of performing control based on gathered information so that service performance is not deteriorated.

The femto BS 120 may divide users into registered users and unregistered users and allow only the registered users to access thereto. A cell that allows only a registered user to access thereto is called a Closed Subscriber Group (hereinafter referred to as a ‘CSG’), and a cell that allows common users to access thereto is called an Open Subscriber Group (hereinafter referred to as an ‘OSG’). Furthermore, the CSG and the OSG may be mixed and operated.

The femto BS 120 may also be called a Home NodeB (HNB) or a Home eNodeB (HeNB). In the following specification, an HNB and an HeNB are collectively called the femto BS 120. A basic object of the femto BS 120 is to provide focused service to only members belonging to a CSG. The femto BS 120, however, may provide service to users other than a CSG depending on the operation mode configuration of the femto BS 120.

The heterogeneous network, consisting of the macro cell, the femto cell, and the pico cell, has been described with reference to FIG. 1, for convenience of description, but the heterogeneous network may be formed of a relay or different types of cells.

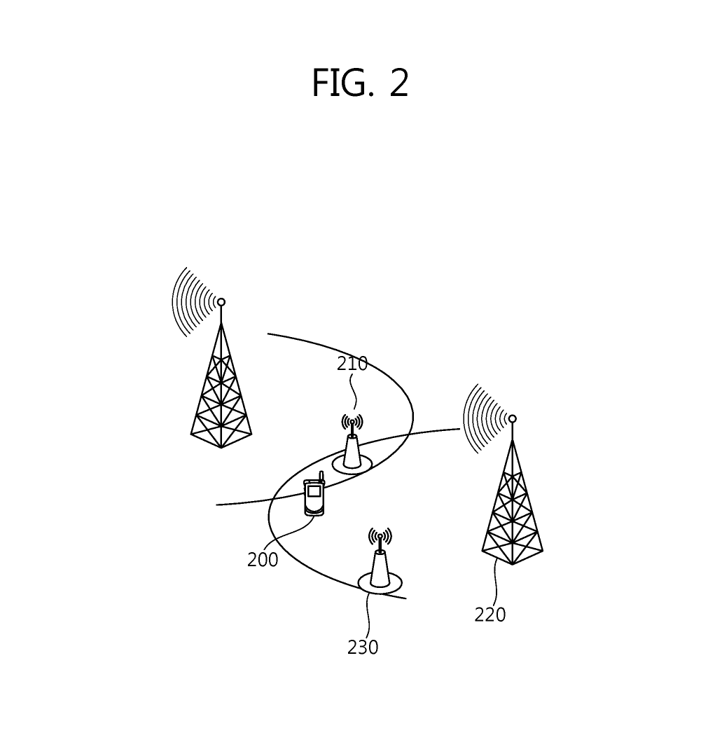

FIG. 2 is a diagram schematically illustrating that a UE is influenced by interference between a macro cell, a femto cell, and a pico cell in downlink.

Referring to FIG. 2, a UE 200 and a femto BS 210 are placed at the cell edge of a macro cell provided by a macro BS 220. The femto BS 210 is in a CSG mode. If the UE 200 is not registered with the CSG regarding the femto BS 210, the UE 200 is unable to access the femto BS 210 having strong signal intensity, and the UE 200 inevitably accesses the macro BS 220 having relatively weaker signal intensity than the femto BS 210. In this case, the UE 200 can receive an interference signal from the femto BS 210.

Furthermore, the UE 200 may use a pico cell provided by a pico BS 230, but may be influenced by interference due to the macro cell 220.

In a heterogeneous network system, a victim cell that is greatly influenced by interference or must be protected from interference in relation to inter-cell interference between a macro cell and a femto cell is the macro cell. On the other hand, an aggressor cell that gives influences to a victim cell or that is less influenced by interference is the femto cell. This is because interference influencing the weak signal of the macro BS 220 is greater than interference influencing the strong weak of the femto BS 210 and the number of users who use the femto BS 210 is much larger than the number of user who uses the macro BS 220. A BS providing a victim cell is called a victim BS, and a BS providing an aggressor cell is called an aggressor BS.

A method of reducing inter-cell interference includes Inter-Cell Interference Coordination (hereinafter referred to as ‘ICIC’) or enhanced ICIC (eICIC). In general, the ICIC method is a method of supporting reliable communication for a UE accessing a victim cell when the UE is influenced by interference from an aggressor cell. In order to coordinate inter-cell interference, restrictions may be imposed to a scheduler in relation to a use of specific time resources or specific frequency resources or both. Furthermore, restrictions may be imposed to a scheduler regarding how much power will be used for specific time resources or specific frequency resources or both. Here, the scheduler may be configured in a victim BS or an aggressor BS.

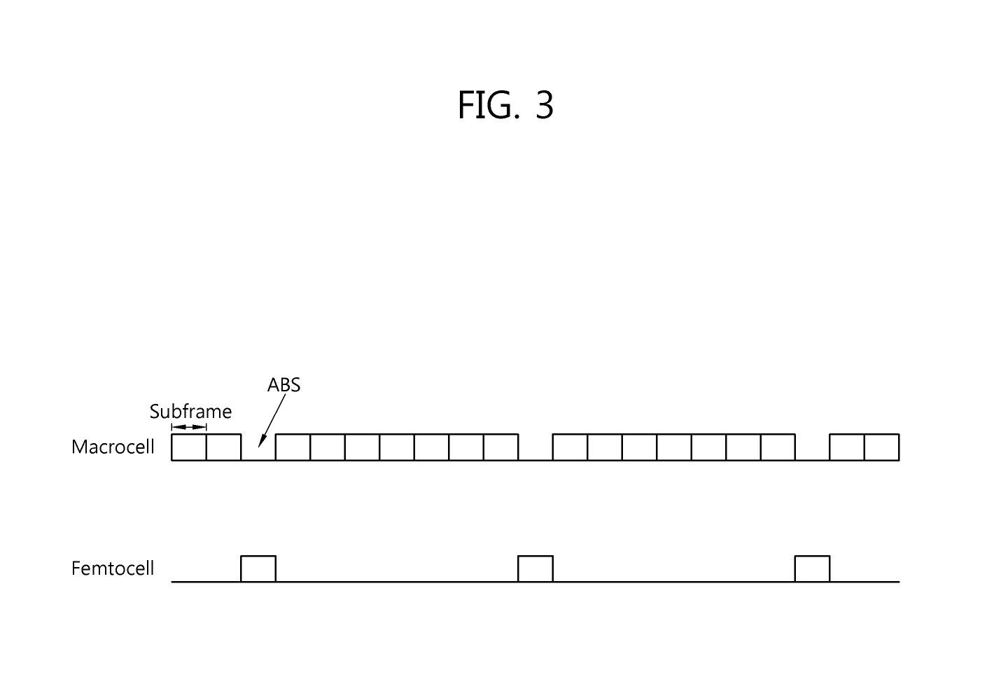

FIG. 3 is a diagram showing a frame pattern for ICIC in a heterogeneous network system.

Referring to FIG. 3, in order to coordinate interference between heterogeneous cells (e.g., between a macro cell and a femto cell or a macro cell and a pico cell), a new frame pattern may be configured. For example, in the third subframe of a macro cell, the macro cell rarely transmits a signal so that the signal strength is extremely low. Accordingly, almost no signal is transmitted in the third subframe, and the subframe is called almost blank subframe (ABS). ABS is occupied by a femto cell and keeps a UE from any interference from an macro cell. Here, an operation of almost blanking the subframe may be implemented by a method in which a BS lowers transmission power for control information and data information to be transmitted in the relevant subframe or a method in which a BS does not transmit some pieces of control information and data information in the relevant subframe. In this case, interference occurring because the macro cell and the femto cell use the same subframe can be avoided. A subframe consisting of a frame of a specific pattern in order to remove interference is called an Almost Blank Subframe (ABS). The frame pattern may also be called an ABS pattern. In the ABS pattern, interference is coordinated by variably configuring a frame pattern structure itself within a specific periodic section consisting of a plurality of subframes.

A method in which heterogeneous cells divide and use subframes (i.e., time resources) among them in order to coordinate interference is called Time Division Multiplexing (hereinafter referred to as ‘TDM’) ICIC. In the TDM ICIC method, an example in which heterogeneous cells divide and use time resources among them by the subframe is described in the present invention, but the example is only an embodiment. That is, the technical spirit of the present invention includes all embodiments in which heterogeneous cells divide and use time resources by the slot, by the frame, or by the specific time that may be defined. Furthermore, the TDM ICIC method according to the present invention is chiefly described by specifying only interference between a macro cell and a femto cell, but this is only example. For example, the TDM ICIC method of the present invention may also be applied to interference between a macro cell and a pico cell and interference between a pico cell and a femto cell.

A macro BS and a femto BS can perform communication on the basis of the ABS pattern. For example, a first subframe may be almost exclusively used by the macro BS, and a second subframe may be almost exclusively used by the femto BS. Alternatively, the macro BS may use the second subframe, used by the femto BS, only for MSs within the macro BS which are in places where the MSs cannot receive the signal of the femto BS. The femto BS may not at all schedule the first subframe because the macro BS exclusively uses the first subframe.

In general, in order to perform scheduling, a BS has to know the state of a downlink channel. The femto BS does not need to receive the state of the downlink channel for the first subframe because it has a low interest in the scheduling of the first subframe. The macro BS and the femto BS may have only to know the states of downlink channels for respective interested subframes. Meanwhile, a UE needs to measure channels only for determined subframes because unnecessary power is consumed and the lifespan of the battery is reduced if the UE performs channel measurement for subframes not related to the UE.

For this reason, the macro BS or the femto BS may want to receive only Channel State Information (hereinafter referred to as ‘CSI’) about a specific subframe, complying with the operation of an ABS pattern, from a UE. For example, the specific subframe can be any subframe. Alternatively, the specific subframe may be an ABS or a non-ABS. The non-ABS has an opposite concept to the ABS.

From a viewpoint if the UE, the UE may measure only a channel state for subframes predetermined by the macro BS or the femto BS and may feed relevant CSI back thereto. A set of subframes where the channel state will be performed by the UE is called a subset. The subset may be predetermined as the subject for which the channel state will be performed by the UE.

The subset functions to limit that the UE performs CSI. The number of subsets is not limited. For example, the number of subsets may be 0 or 2. For example, a first subset may be {0, 2, 4}, and a second subset may be {1, 3, 5}. In a subset {a}, ‘a’ is the index of a subframe. The subset may be indicated by a bitmap. For example, it is assumed that subframes included in a subset, from among all the subframes 1, 2, 3, 4, and 5, are {2, 4, 5}. When the subframes are sequentially mapped to a bitmap, the bitmap indicates 01011. If the bit is 1, a relevant subframe is included in the subset. If the bit is 0, the relevant subframe is not included in the subset.

Subset configuration information is related to the configuration of the subset. The subset configuration information may be transmitted to a UE through the Radio Resource Control (RRC) signaling of a BS. In the above example, a BS informs a UE that the first subset has been configured as {0, 2, 4} and the second subset has been configured as {1, 3, 5} in the form of subset configuration information.

A mode in which a UE and a BS are operated on the basis of ICIC is called an ICIC mode. In the ICIC mode, a subset may be used to limit the measurement of a UE. For example, in the ICIC mode, a UE may transmit only CSI about a subframe placed at a predetermined position. This is because it may be overhead to the UE if a channel state for all the subsets is measured and a BS has only to obtain CSI about a necessary subset. To this end, the BS is required to inform the UE of a subset requiring CSI, from among a plurality of subsets. For example, the BS may request CSI about a first subset or CSI about a second subset. The UE feeds the pieces of CSI about the subsets, indicated by the BS, back to the BS. For example, if the BS indicates the second subset (e.g., {1, 3, 5}), the UE may feed a periodic feedback parameter or aperiodic feedback signaling set by the BS and CSI selected according to the parameter, from among CSI about the subframe 1, CSI about the subframe 3, and CSI about the subframe 5, back to the BS.

As a method of indicating the subset, a subset indicator (i.e., additional information to indicate the subset) may be newly defined within DCI (or an uplink grant) of a format 0 or 4. Here, the subset indicator has 1 bit. If the bit is ‘0’, the subset indicator may indicate a first subset, and if the bit is ‘1’, the subset indicator may indicate a second subset. To additionally add the subset indicator, however, may cause additional blind decoding overhead to a UE because the addition of the subset indicator corresponds to a modification of the existing DCI format. In order to avoid the blind decoding overhead, another method of efficiently indicating the subset is required.

CSI and a cell set are described in detail below.

CSI refers to information indicating a channel state for a transmission link (e.g., downlink), and a UE may know a channel state by measuring a CSI reference signal for measuring the channel state. CSI may include, for example, a Channel Quality Indicator (CQI), a Precoding Matrix Indicator (PMI), and a Rank Indicator (RI). Alternatively, CSI may also refer to information induced by a CQI, a PMI, and an RI.

The CQI indicates a Modulation and Coding Scheme (MCS) level suitable for a measured channel state. For example, the CQI may be listed as in Table 1 below.

TABLE 1

| CQI INDEX | MODULATION |
|---|---|
| 0 | Out of range |
| 1 | QPSK |
| 2 | QPSK |
| 3 | QPSK |
| 4 | QPSK |
| 5 | QPSK |
| 6 | QPSK |
| 7 | 16QAM |
| 8 | 16QAM |
| 9 | 16QAM |
| 10 | 64QAM |
| 11 | 64QAM |
| 12 | 64QAM |
| 13 | 64QAM |
| 14 | 64QAM |
| 15 | 64QAM |

The PMI provides information about a precoding matrix in codebook-based precoding. The PMI is related to Multiple Input Multiple Output (MIMO). To feed the PMI back in MIMO is called closed-loop MIMO.

The RI is information about the number of layers or a rank which is recommended by a UE. The rank is the number of non-zero eigenvalues of an MIMO channel matrix and may be defined by the number of spatial streams that may be multiplexed.

The RI is always related to one or more CQI feedbacks. That is, a feedback CQI is calculated assuming a specific RI value. The RI may be fed back by a frequency smaller than that of a CQI because the rank of a channel is changed more slowly than the CQI. For example, the transmission cycle of an RI may be a multiple of the transmission cycle of a CQI or a PMI.

A method of transmitting or reporting a CSI includes a periodic transmission method and an aperiodic transmission method. In the periodic transmission method, the CSI may be transmitted on a Physical Uplink Control CHannel (PUCCH) or on a Physical Uplink Shared CHannel (PUSCH). In the aperiodic transmission method, a report on a fine channel state having a larger capacity is possible because the CSI is transmitted on a PUSCH. A BS requests a UE to perform the aperiodic transmission method when a more precise CSI is necessary. This request is made when the BS transmits CSI request information to the UE. The CSI request information may be included in Downlink Control Information (hereinafter referred to as ‘DCI’) of a format 0 or a format 4. The DCI of the format 0 or the format 4 may be called an uplink grant. If the CSI request information is included in the DCI of the format 0 or the format 4, it may be considered as one field. In this case, the CSI request information may be called a CSI request field.

The CSI request information may be represented by 1 bit or 2 bits. If the CSI request information is represented by 1 bit, it corresponds to the case where a BS configures only one serving cell for a UE. If the CSI request information is represented by 2 bits, it corresponds to the case where a BS configures two or more serving cells for a UE. For example, after the first one serving cell is configured, the CSI request information of 1 bit may be used. Next, the BS may additionally configure one or more serving cells for the UE. The CSI request information of 2 bits may be used after the additional serving cells are configured.

TABLE 2

| VALUE OF | |
|---|---|
| CSI REQUEST | INDICATED CONTENTS |
| 0 | No aperiodic CSI report |
| 1 | Triggering of an aperiodic CSI report on a serving cell |

Referring to Table 2, if a value of the CSI request information is 1, an aperiodic CSI report on a serving cell is triggered.

Meanwhile, CSI request information supporting a UE in which at least one serving cell (or a plurality of component carriers) is configured may be defined. The following table is an example showing the contents indicated by CSI request information of 2 bits.

TABLE 3

| VALUE OF | |
|---|---|
| CSI REQUEST | INDICATED CONTENTS |
| 00 | No triggering of an aperiodic CSI report |
| 01 | Triggering of an aperiodic CSI report on a serving cell |
| 10 | Triggering of a CSI report on the serving cells of a |
| | first cell set configured by a high layer |
| 11 | Triggering of a CSI report on the serving cells of a |
| | second cell set configured by a high layer |

Referring to Table 3, if the value of the CSI request information is 01, an aperiodic CSI report on a serving cell is triggered. Here, the CSI relates to downlink component carriers linked together on the basis of an uplink component carrier on which the CSI will be transmitted and uplink frequency information defined within System Information Block (SIB) 2. Furthermore, if the values of the CSI request information and 10 and 11, it refers to the triggering of a CSI report on the serving cells of the first cell set and the triggering of a CSI report on the serving cells of the second cell set, respectively. Here, the cell set indicates a set including at least one serving cell configured by a high layer for a UE. For example, the first cell set may be {a serving cell1, a serving cell2, a serving cell3}, and the second cell set may be {a serving cell°, a serving cell4}. If the value of the CSI request information is 10, a UE transmits pieces of CSI about the first cell set (i.e., CSI about the serving cell1, CSI about the serving cell2, and CSI about the serving cell3) to a macro BS, a pico BS, or a femto BS.

Information indicating the configuration of a cell set is referred to as cell set configuration information. The cell set configuration information may be transmitted through RRC signaling, Medium Access Control (MAC) signaling, or the signaling of a physical layer.

The concept of a serving cell may be defined in a Carrier Aggregation (CA). An individual unit carrier bound by a CA is called a Component Carrier (hereinafter referred to as a ‘CC’). A CC used in downlink transmission is called a DownLink CC (DL CC), and a CC used in uplink transmission is called an UpLink CC (UL CC). Each CC is defined by a bandwidth and a center frequency. The CC may correspond to a serving cell. A DL CC may configure one serving cell, or a DL CC and an UL CC may be linked to configure one serving cell. However, a serving cell is not configured by only one UL CC.

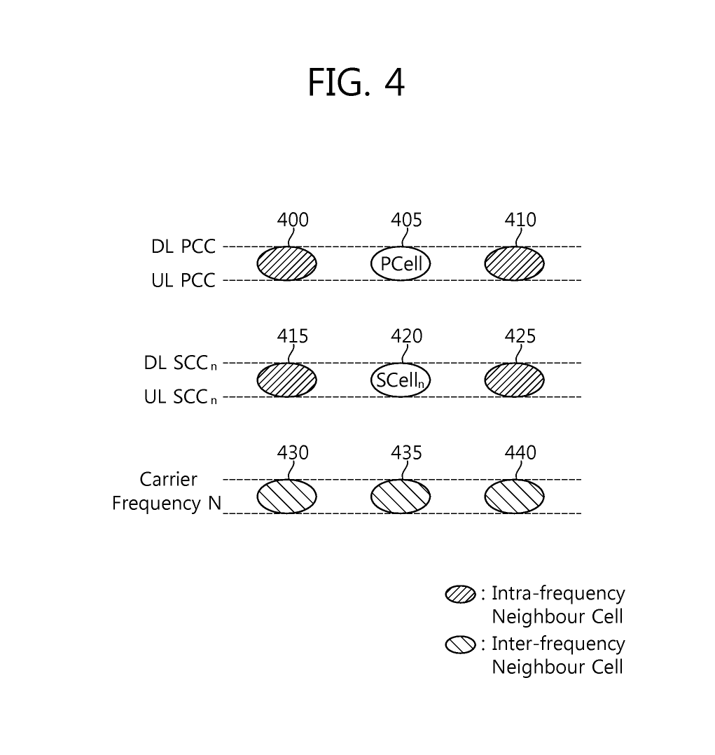

FIG. 4 is an explanatory diagram illustrating the concept of a Primary Serving Cell (hereinafter referred to as a ‘PCell’) and a Secondary Serving Cell (hereinafter referred to as an ‘SCell’).

Referring to FIG. 4, serving cells include a PCell 405 and an SCell 420. The remaining cells 400, 410, 415, 425, 430, 435 and 440 other than the serving cells are called neighbor cells. The PCell 405 refers to one serving cell which provides security input and NAS mobility information in an RRC establishment or re-establishment state. At least one cell, together with the PCell 405, may be configured to form a set of serving cells depending on the capabilities of a UE. Here, the at least one cell is called the SCell 420. Accordingly, one group may consist of only the one PCell 405 or may consist of the one PCell 405 and the at least one SCell 420.

A DL CC corresponding to the PCell 405 is called a DownLink Primary Component Carrier (hereinafter referred to as a ‘DL PCC’), and a UL CC corresponding to the PCell 405 is called an UpLink Primary Component Carrier (hereinafter referred to as an ‘UL PCC’). Furthermore, in downlink, a DL CC corresponding to the SCell 420 is called a DownLink Secondary Component Carrier (DL SCC). In uplink, a UL CC corresponding to the SCell 420 is called an UpLink Secondary Component Carrier (UL SCC).

Each of the PCell 405 and the SCell 420 has the following characteristics.

First, the PCell 405 is used to transmit a PUCCH.

Second, the PCell 405 is always activated, whereas the SCell 420 is a carrier activated or deactivated depending on a specific condition.

Third, when the PCell 405 experiences a Radio Link Failure (hereinafter referred to as an ‘RLF’), RRC establishment is triggered. When the SCell 420 experiences an RLF, RRC establishment is not triggered.

Fourth, the PCell 405 may be changed by a change of a security key or a handover procedure accompanied by a Random Access Channel (RACH) procedure. In case of MSG4 (contention resolution), only a PDCCH indicating MSG4 must be transmitted on the PCell 405, and MSG4 information may be transmitted on the PCell 405 or the SCell 420.

Fifth, Non-Access Stratum (NAS) information is received on the PCell 405.

Sixth, the PCell 405 is always composed of a pair of a DL PCC and an UL PCC.

Seventh, a different CC may be configured to the PCell 405 for every UE.

Eighth, procedures, such as the reconfiguration, addition, and removal of the SCell 420, may be performed by an RRC layer. In adding the new SCell 420, RRC signaling may be used to transmit system information about a dedicated SCell.

The technical spirit of the present invention regarding the characteristics of the PCell 405 and the SCell 420 is not necessarily limited to the above description. The characteristics of the PCell 405 and the SCell 420 are only illustrative, and they may include larger examples.

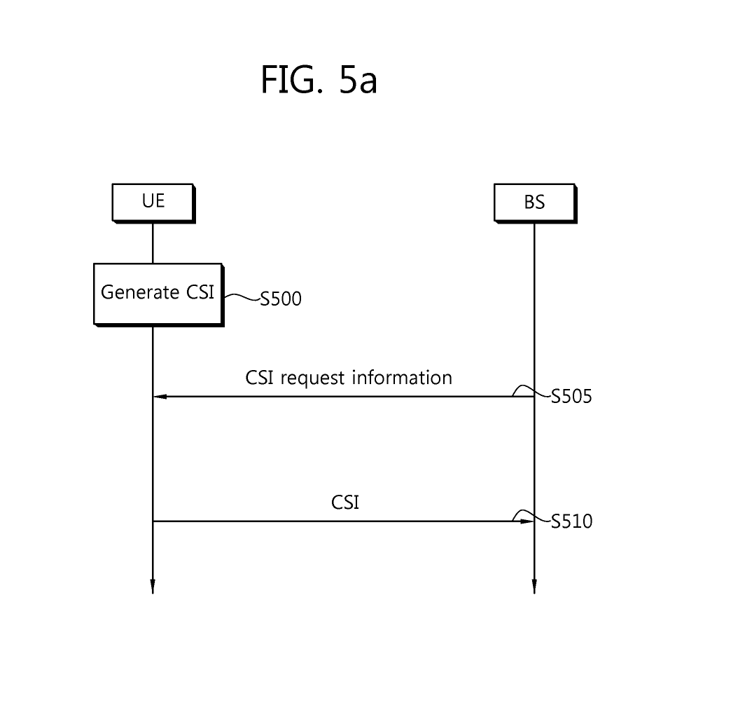

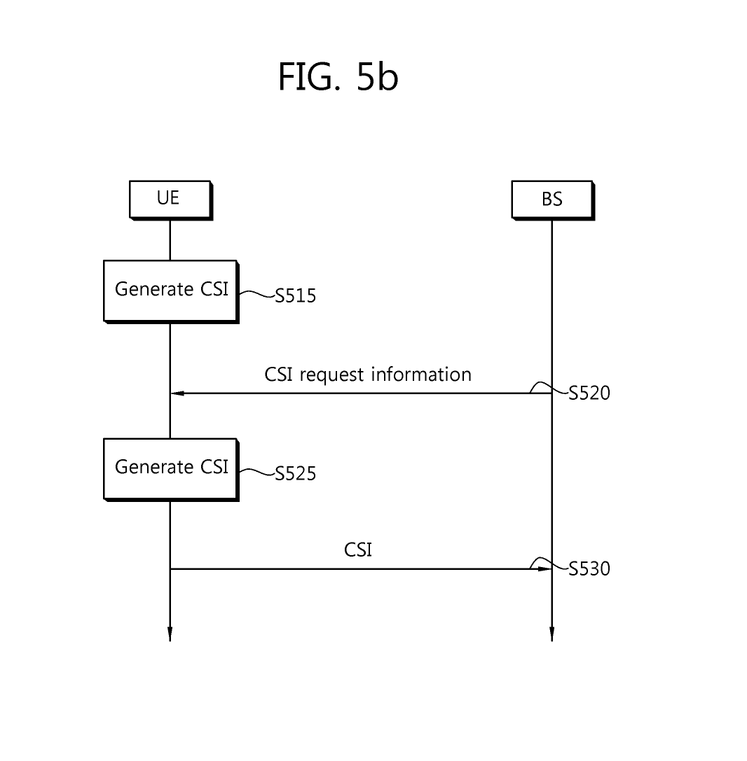

FIG. 5a is a flowchart illustrating a method of transmitting CSI according to an embodiment of the present invention.

Referring to FIG. 5a, a UE measures a channel state and generates CSI based on the measured channel state at step S500. If a report on the CSI is performed on the basis of a subset, the UE generates the CSI about the subset. If there are several subsets, the UE generates and stores CSI about the some subsets. For example, if two or more serving cells are configured in the UE, the UE generates CSI about a subset in all the configured serving cells. For another example, if two or more serving cells are configured in the UE, the UE generates CSI about a subset in some of all the configured serving cells. Here, the some serving cells may be activated serving cells.

The UE may generate the CSI of the subset on condition that the UE is operated in the ICIC mode. Furthermore, in order for the UE to be operated in the ICIC mode, the UE may receive ICIC mode activation information (hereinafter referred to as ‘coordination mode activation information’) from a BS. The reception of the coordination mode activation information is an embodiment in which the UE enters the ICIC mode, but is not an essential element. The coordination mode activation information may also be referred to as a coordination mode enable message or an ICIC enable message.

A BS transmits CSI request information to the UE at step S505. The CSI request information may be included in DCI of a format 0 or a format 4 and transmitted. The CSI request information may have 1 bit or 2 bits. The CSI request information is transmitted on a Physical Downlink Control Channel (PDCCH). For example, the CSI request information may instruct the triggering of a CSI report on an activated serving cell within a specific cell set. Alternatively, the CSI request information may instruct the triggering of a CSI report on a subset in the activated serving cell.

The UE transmits the CSI to the BS at step S510. According to the above embodiment, the UE transmits the CSI to the BS based on the indication of the CSI request information. For example, the UE may transmit CSI about an activated serving cell within a specific cell set to the BS.

FIG. 5b is a flowchart illustrating a method of transmitting CSI according to another embodiment of the present invention.

Referring to FIG. 5b, if a report on CSI is performed on the basis of a subset, a UE generates the CSI about the subset at step S515. If there are several subsets, the UE generates and stores CSI about the some subsets. For example, if two or more serving cells are configured in the UE, the UE generates CSI about a subset in all the configured serving cells. For another example, if two or more serving cells are configured in the UE, the UE generates CSI about a subset in some of the configured serving cells. Here, the some serving cells may be activated serving cells.

The UE may generate the CSI of the subset on condition that the UE is operated in the ICIC mode. Furthermore, in order for the UE to be operated in the ICIC mode, the UE may receive coordination mode activation information from the BS. The reception of the coordination mode activation information is an embodiment in which the UE enters the ICIC mode, but is not an essential element. The coordination mode activation information may also be referred to as a coordination mode enable message or an ICIC enable message.

The BS transmits CSI request information to the UE at step S520. The CSI request information may be included in DCI of a format 0 or a format 4 and transmitted. The CSI request information may have 1 bit or 2 bits. The CSI request information is transmitted on a PDCCH. For example, the CSI request information may instruct the triggering of a CSI report on an activated serving cell within a specific cell set. Alternatively, the CSI request information may instruct the triggering of a CSI report on a subset in the activated serving cell.

If the BS simultaneously requests CSI about serving cells other than serving cells to which the ICIC mode is applied, the UE measures a channel state for the serving cells on the basis of a subframe received after an n^{th} subframe from among subframes in which the channel state information request message has been received and generates CSI about the serving cells at step S525. Here, the n value may be one of 0 to 3.

The UE transmits the CSI about all the serving cells to the BS at step S530. According to the above embodiment, the UE transmits the CSI to the BS according to the indication of the CSI request information. For example, the UE may transmit CSI about an activated serving cell within a specific cell set to the BS.

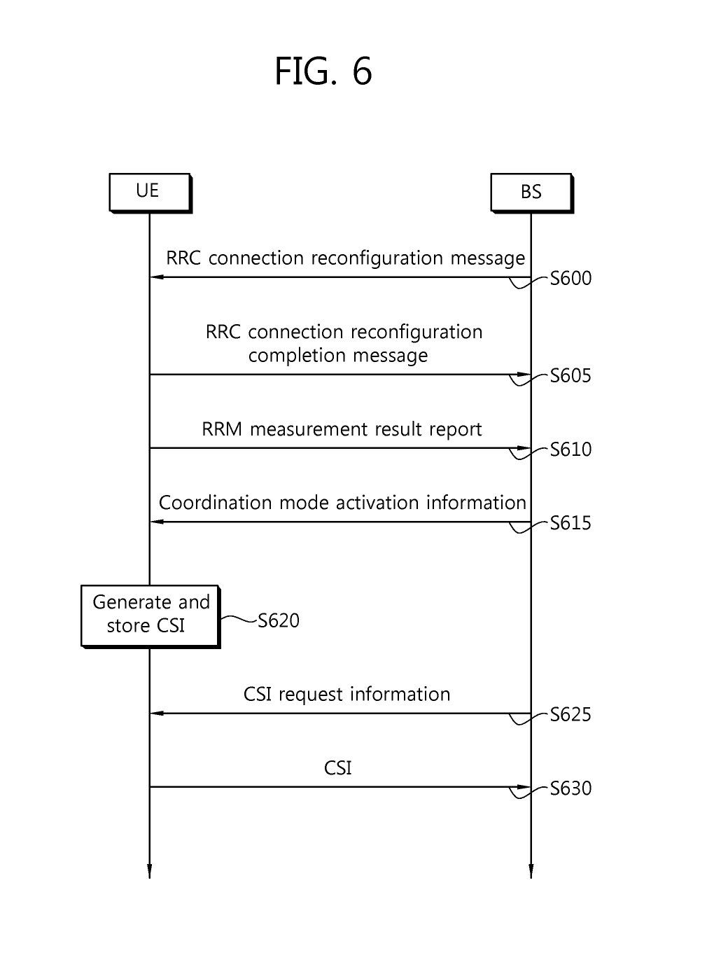

FIG. 6 is a flowchart illustrating a method of transmitting CSI according to yet another embodiment of the present invention. Unlike the embodiment of FIG. 5, the embodiment of FIG. 6 includes a process of receiving coordination mode activation information as a precondition that a UE enters the ICIC mode. In the embodiment of FIG. 6, the process of receiving coordination mode activation information is described to be part of a Radio Resource Control (RRC) connection reconfiguration procedure or a Radio Resource Management (RRM) procedure, but this is only illustrative. The coordination mode activation information may also be transmitted through a Medium Access Control (MAC) message or physical layer signaling in addition to an RRC message.

Referring to FIG. 6, a BS transmits an RRC connection reconfiguration message to a UE at step S600. For example, the RRC connection reconfiguration message may be included in configuration information for an aperiodic CSI report necessary for the UE. If the UE does not obtain the configuration information for an aperiodic CSI report from the BS, the UE uses information, configured by default, as CSI. For example, the information configured by default may be channel quality information about all the frequency bands.

For another example, the RRC connection reconfiguration message may include first subset configuration information for a CSI measurement restriction or second subset configuration information for an RRM/Radio Link Monitoring (RLM) measurement restriction or both. The first subset configuration information or the second subset configuration information may be included in the RRC connection reconfiguration message or a message of another form and may be transmitted to the UE as independent information.

For yet another example, the RRC connection reconfiguration message may include definition information in which the meaning of the value of CSI request information is defined.

For yet another example, the RRC connection reconfiguration message may further include RRM measurement configuration information from which the ICIC mode for the UE has been activated. Here, the activation of an ICIC mode related to the measurement of CSI and the activation of an ICIC mode related to RRM/RLM measurement may be separately configured in the RRM measurement configuration information, and they may be configured as a single operation.

The UE reconfigures an RRC connection in response to the RRC connection reconfiguration message and transmits an RRC connection reconfiguration completion message to the BS at step S605. For example, the UE may change the configuration information for the aperiodic CSI report, the subset configuration information, the definition information, or the RRM measurement configuration information. Alternatively, all or some of the changes may be changed at the same time.

The UE performs RRM measurement on the basis of the changed RRM measurement configuration information and reports the result of the RRM measurement to the BS at step S610. The result of the RRM measurement may be periodically changed according to setting and may be dependently transmitted based on the result of the RRM measurement. A procedure of reporting the result of the RRM measurement may be omitted according to circumstances. In FIG. 6, the embodiment in which the result of the RRM measurement is reported is described as an example.

The BS transmits coordination mode activation information to the UE on the basis of the result of the RRM measurement at step S615. The coordination mode activation information may be divided into first coordination mode activation information related to CSI measurement and second coordination mode activation information related to RRM/RLM measurement and then transmitted or may be transmitted as a single indicator. If the coordination mode activation information is transmitted as a single indicator, the activations of the ICIC modes related to the two kinds of measurements may be performed at the same time. The coordination mode activation information may be the message of a MAC layer, the message of an RRC layer, or physical layer signaling.

The UE may switch to the ICIC mode on the basis of the coordination mode activation information. The UE can measure a channel state for a limited subset owing to the ICIC mode. The UE measures a channel state for each subset, generates CSI based on the measured channel state, and stores the generated CSI in memory or a buffer at step S620. If there is CSI newly generated or measured on the basis of each subset, previous CSI is discarded and updated into the new CSI for every subset.

If CSI is necessary, the BS transmits CSI request information, requesting periodic CSI, to the UE at step S625. The CSI request information may be included in common control information or control information dedicated to the UE and then transmitted. For example, the CSI request information may be included in DCI of a format 0 or a format 4 for an uplink grant. For example, the CSI request information may instruct the triggering of a CSI report on an activated serving cell within a specific cell set. Alternatively, the CSI request information may instruct the triggering of a CSI report on a subset within the activated serving cell.

The UE transmits the CSI to the BS at step S630. The CSI may be included in an uplink data channel (PUSCH) and transmitted.

The CSI request information is described in more detail below. The CSI request information may have a different meaning according to its value. For example, if the value of the CSI request information is ‘0’, it may mean that a report on CSI has not been triggered. If the value of the CSI request information is ‘1’, it may mean that a report on CSI has been triggered.

In the state in which the ICIC mode has been activated, a report on CSI by a UE is limited. For example, the UE may report only CSI about a specific subset in a specific serving cell. Accordingly, it is necessary to clearly define, in the CSI request information, that a UE will report CSI about what subset in what serving cell. To this end, the CSI request information may be defined as in the following embodiments.

For example, the CSI request information may be 1 bit information. In this case, the CSI request information may be defined as in Table 4. Table 4 corresponds to the case where the number of serving cells configured in a UE is only one (i.e., a non-CA environment).

TABLE 4

| VALUE OF | |
|---|---|
| CSI REQUEST | INDICATED CONTENTS |
| 0 | No triggering of aperiodic CSI report |
| 1 | Triggering of an aperiodic CSI report on |
| | If a UE is in the ICIC mode, a CSI report on first and |
| | second subsets is triggered. |

Referring to Table 4, if a value of the CSI request information is 0, it means that an aperiodic CSI report has not been triggered. If a value of the CSI request information is 1, it means that a CSI report on both a first subset and a second subset has been triggered. In this case, a UE measures CSI about the first subset and CSI about the second subset and triggers a CSI report.

For another example, the CSI request information may be 2-bit information. In this case, the CSI request information may be defined as in Table 5.

TABLE 5

| VALUE OF | |
|---|---|
| CSI REQUEST | INDICATED CONTENTS |
| 00 | No triggering of an aperiodic CSI report |
| 01 | Triggering of an aperiodic CSI report |
| | If a UE is in the ICIC mode, a CSI report on first |
| | and second subsets is triggered. |
| 10 | Triggering of an aperiodic CSI report on an activated |
| | serving cell |
| | If a UE is in the ICIC mode, a CSI report on a first |
| | subset is triggered. |
| 11 | Triggering of an aperiodic CSI report on an activated |
| | serving cell |
| | If a UE is in the ICIC mode, a CSI report on a second |
| | subset is triggered. |

Referring to Table 5, if a value of the CSI request information is 01, an aperiodic CSI report on a serving cell is triggered. Here, the CSI relates to uplink component carriers on which the CSI will be transmitted and downlink component carriers linked on the basis of uplink frequency information defined in SIB2. If a value of the CSI request information is 10 or 11, a CSI report on all the activated serving cells is triggered. If a UE is in the ICIC mode and the value of CSI request information is 10, it means that a CSI report on a first subset in an activated serving cell is triggered. Furthermore, if a UE is in the ICIC mode and the value of CSI request information is 11, it means that a CSI report on a second subset in an activated serving cell is triggered.

For yet another example, the CSI request information may have 2-bit information. In this case, the CSI request information may be defined as in Table 6.

TABLE 6

| VALUE OF | |
|---|---|
| CSI REQUEST | INDICATED CONTENTS |
| 00 | No triggering of an aperiodic CSI report |
| 01 | Triggering of an aperiodic CSI report |
| | If a UE is in the ICIC mode, a CSI report on first |
| | and second subsets in a PCell is triggered. |
| 10 | Triggering of an aperiodic CSI report on an activated |
| | serving cell |
| | If a UE is in the ICIC mode, a CSI report on a first |
| | subset in a PCell is triggered. |
| 11 | Triggering of an aperiodic CSI report on an activated |
| | serving cell |
| | If a UE is in the ICIC mode, a CSI report on a second |
| | subset in a PCell is triggered. |

Referring to Table 6, if a value of the CSI request information is 01, an aperiodic CSI report on a serving cell is triggered. Here, the CSI relates to uplink component carriers on which the CSI will be transmitted and downlink component carriers linked on the basis of uplink frequency information defined in SIB2 and relates to the case where the serving cell is a PCell. If a UE is in the ICIC mode and the value of CSI request information is 01, it means that a CSI report on a first subset and a second subset within the PCell are triggered.

If a value of the CSI request information is 10 or 11, a CSI report on all the activated serving cells is triggered. If a UE is in the ICIC mode and the value of CSI request information is 10, it means that a CSI report on a first subset in a PCell is triggered. Furthermore, if a UE is in the ICIC mode and the value of CSI request information is 11, it means that a CSI report on a second subset in a PCell is triggered.

Table 4 to Table 6 indicate pieces of CSI request information with consideration taken of the case where a UE is operated in the ICIC mode and the case where a UE is not operated in the ICIC mode.

Embodiments of CSI request information by taking the case where a UE is operated in the ICIC mode into consideration are described below.

For yet another example, CSI request information has 2-bit information. In this case, the CSI request information may be defined as in Table 7.

TABLE 7

| VALUE OF | |
|---|---|
| CSI REQUEST | INDICATED CONTENTS |
| 00 | No triggering of an aperiodic CSI report |
| 01 | Triggering of an aperiodic CSI report |
| 10 | Triggering of an aperiodic CSI report on first and |
| | second subsets in a first cell set configured through |
| | RRC |
| 11 | Triggering of an aperiodic CSI report on first and |
| | second subsets in a second cell set configured through |
| | RRC |

Referring to Table 7, if a value of the CSI request information is 01, an aperiodic CSI report on a serving cell is triggered. Here, the CSI relates to uplink component carriers on which the CSI will be transmitted and downlink component carriers linked on the basis of uplink frequency information defined in SIB2. If a value of CSI request information is 10 or 11, a CSI report on both first and second subsets is triggered. In particular, if a value of the CSI request information is 10, it means that a CSI report in a first cell set is triggered. If a value of CSI request information is 11, it means that a CSI report in a second cell set is triggered. Here, the first cell set and the second cell set may be configured through RRC.

A UE may perform a CSI report under some restrictions based on the state of a serving cell configured in the UE (e.g., whether the serving cell is included in a cell set and whether the serving cell has been activated). The state of the serving cell configured in the UE may be classified into the following four kinds of states depending on whether the serving cell is included in a cell set and whether the serving cell has been activated.

TABLE 8

| | INCLUDED IN | |
|---|---|---|
| STATES | CELL SET | ACTIVATED |
| First state | ◯ | ◯ |
| Second state | ◯ | X |
| Third state | X | ◯ |
| Fourth state | X | X |

Referring to Table 8, the first state corresponds to the case where a serving cell configured in a UE is included in a cell set and is in an activated state. The second state corresponds to the case where a serving cell configured in a UE is included in a cell set and is in a deactivated state. The third state corresponds to the case where a serving cell configured in a UE is not included in a cell set and is in an activated state. The fourth state corresponds to the case where a serving cell configured in a UE is not included in a cell set and is in a deactivated state. The third state may actually do not exist.

The serving cell of the first state may become the subject of a CSI report. Regarding the serving cell of the second state, the UE does not report CSI or transmits a preset default value because the UE does not measure a channel state. Regarding the serving cells of the third and the fourth states, a UE does not report CSI. This is because a deactivated serving cell will not be used and thus CSI is unnecessary.

For example, it is assumed that serving cells configured in a UE are {a serving cell 0, a serving cell 1, a serving cell 2}, a first cell set is {the serving cell 0, the serving cell 1}, and an activated serving cell is {the serving cell 0}. In this case, the serving cell 0 is in the first state, the serving cell 1 is in the second state, and the serving cell 2 is in the fourth state. If a UE receives CSI request information having the value 01 in Table 7, the UE triggers a CSI report on the serving cells of the first cell set. Here, the UE triggers a CSI report on the serving cell 0 of the first state and does not trigger a CSI report on the serving cell 1 of the second state or triggers a report based on a default value. Furthermore, the UE does not trigger a CSI report on the serving cell 2 of the fourth state. That is, a CSI report on serving cells is not triggered although all the serving cells are included in a cell set, but a CSI report on only some serving cells satisfying a specific condition is triggered.

Meanwhile, CSI about the serving cell of the first state may not be measured or stored. For example, measured CSI may do not exist because the CSI is not measured after a serving cell was changed from a deactivation state to an activation state. In this case, a UE may transmit a preset default value. The default value may be set to a value that cannot exist as a value of CSI, such as −1 or Out Of Range (OOR).

For still yet another example, CSI request information may have 2-bit information. In this case, the CSI request information may be defined as in Table 9.

TABLE 9

| Value of | |
|---|---|
| CSI request | INDICATED CONTENTS |
| 00 | No triggering of an aperiodic CSI report |
| 01 | Triggering of an aperiodic CSI report |
| 10 | Triggering of an aperiodic CSI report on an activated |
| | serving cell in a first cell set |
| 11 | Triggering of an aperiodic CSI report on an activated |
| | serving cell in a second cell set |

In Tables 3 to 9, the example in which a maximum number of subsets that may be configured in a UE are 2 has been assumed and described, but the example is only illustrative. The number of subsets that may be configured in a UE may be 2 or more or 2 or less.

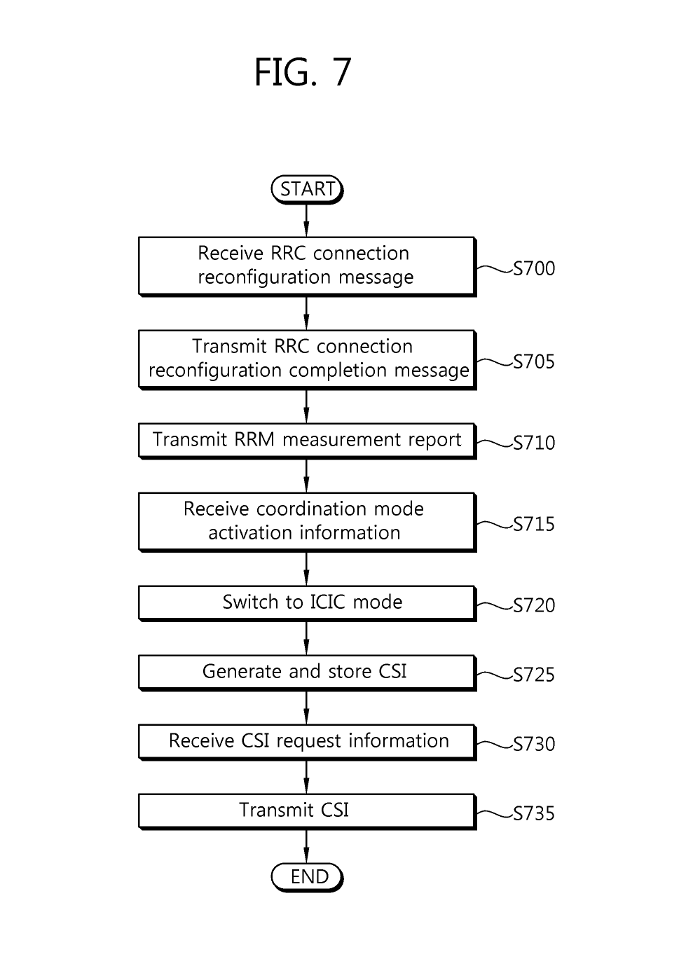

FIG. 7 is a flowchart illustrating a method of a UE transmitting CSI according to an embodiment of the present invention.

Referring to FIG. 7, the UE receives at least one of configuration information for an aperiodic CSI report, first subset configuration information for a CSI measurement restriction, second subset configuration information for an RRM/RLM measurement restriction, definition information regarding CSI request information, and RRM measurement configuration information from a BS at step S700. For example, the configuration information for an aperiodic CSI report, the first subset configuration information for a CSI measurement restriction, the second subset configuration information for an RRM/RLM measurement restriction, the definition information regarding CSI request information, and the RRM measurement configuration information may be included in an RRC message (e.g., an RRC connection reconfiguration message).

The UE reconfigures an RRC connection in response to the RRC connection reconfiguration message and transmits an RRC connection reconfiguration completion message to the BS at step S705. For example, the UE may change the configuration information for an aperiodic CSI report, the subset configuration information, the definition information regarding CSI request information, or the RRM measurement configuration information. Alternatively, all or some of the changes may be changed at the same time.

The UE performs Radio Resource Management (RRM) on the basis of the changed RRM measurement configuration information and reports the result of the RRM measurement to the BS at step S710. Here, the result of the RRM measurement may be periodically transmitted according to setting or may be dependently transmitted based on the result of the RRM measurement.

The UE receives coordination mode activation information from the BS at step S715. The coordination mode activation information may be divided into first coordination mode activation information related to CSI measurement and second coordination mode activation information related to RRM/RLM measurement and then transmitted or may be transmitted as a single indicator. If the coordination mode activation information is a single indicator, the activations of the ICIC modes related to the two kinds of measurements may be performed at the same time. The coordination mode activation information may be the message of a MAC layer, the message of an RRC layer, or physical layer signaling.

The UE switches to the ICIC mode on the basis of the coordination mode activation information at step S720. A restriction may be imposed to the measurement of a channel state by a serving cell or may be imposed to a CSI report owing to the ICIC mode. That is, the UE can measure a channel state for only some serving cells (e.g., activated serving cells).

The UE measures a channel state for a subset, generates CSI based on the measured channel state, and stores the generated CSI in memory or a buffer at step S725. If there is CSI newly generated or measured on the basis of each subset, previous CSI is discarded and updated with the new CSI for every subset.

The UE receives CSI request information, requesting aperiodic CSI, from the BS at step S730. The CSI request information may be included in common control information or control information dedicated to the UE and then transmitted. For example, the CSI request information may be included in DCI of a format 0 or a format 4 for an uplink grant.

The UE transmits the CSI to the BS at step S735. The CSI may be included in an uplink data channel and transmitted.

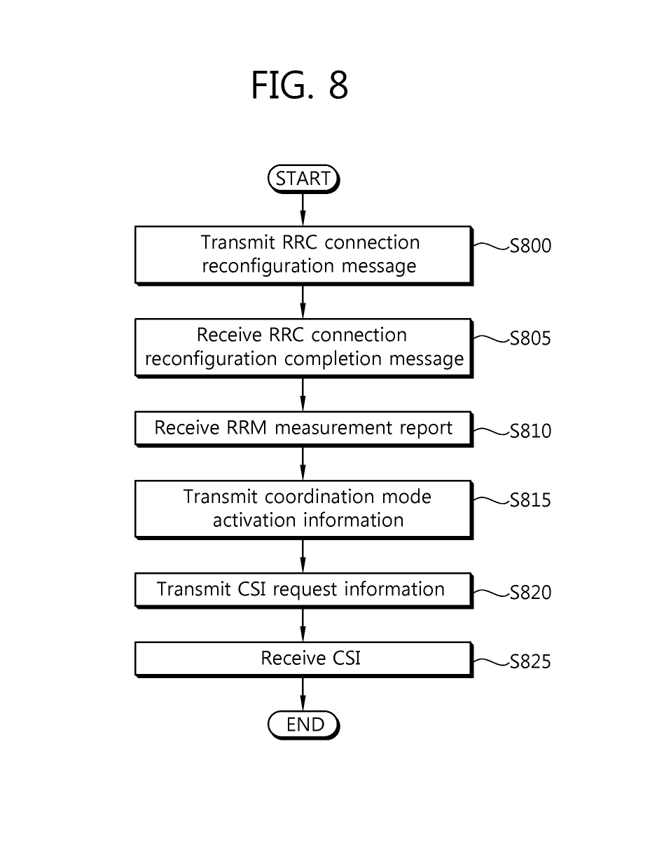

FIG. 8 is a flowchart illustrating a method of a BS receiving CSI according to an embodiment of the present invention.

Referring to FIG. 8, the BS transmits an RRC connection reconfiguration message to a UE at step S800. For example, the RRC connection reconfiguration message may include configuration information for an aperiodic CSI report necessary for the UE. If the UE has not obtained the configuration information for the aperiodic CSI report from the BS, the UE uses information, configured by default, as CSI. For example, the information configured by default may be channel quality information about all the frequency bands.

For another example, the RRC connection reconfiguration message may include first subset configuration information for a CSI measurement restriction or second subset configuration information for an RRM/RLM measurement restriction or both. The first subset configuration information or the second subset configuration information may be included in the RRC connection reconfiguration message or a message of another form and may be transmitted to the UE as independent information.

For yet another example, the RRC connection reconfiguration message may include definition information to define the meaning of a value of CSI request information.

For yet another example, the RRC connection reconfiguration message may further include RRM measurement configuration information on which the activation of the ICIC mode for the UE may be determined. The activation of an ICIC mode related to CSI measurement and the activation of an ICIC mode related to RRM/RLM measurement may be separately configured in the RRM measurement configuration information or may be configured in the RRM measurement configuration information as a single operation.

The BS receives an RRC connection reconfiguration completion message from the UE at step S805.

The BS receives the result of RRM measurement from the UE at step S810. The step S810 may be omitted according to circumstances.

The BS transmits coordination mode activation information to the UE at step S815. The coordination mode activation information may be divided into first coordination mode activation information related to CSI measurement and second coordination mode activation information related to RRM/RLM measurement and then transmitted or may be transmitted as a single indicator. If the coordination mode activation information is a single indicator, the activations of the ICIC modes related to the two kinds of measurements may be performed at the same time. The coordination mode activation information may be the message of a MAC layer, the message of an RRC layer, or physical layer signaling.

The BS transmits CSI request information, requesting aperiodic CSI, to the UE at step S820. The CSI request information may be included in common control information or control information dedicated to the UE and then transmitted. For example, the CSI request information may be included in DCI of a format 0 or a format 4 for an uplink grant.

The BS receives CSI from the UE at step S825. The CSI may be included in an uplink data channel and transmitted.

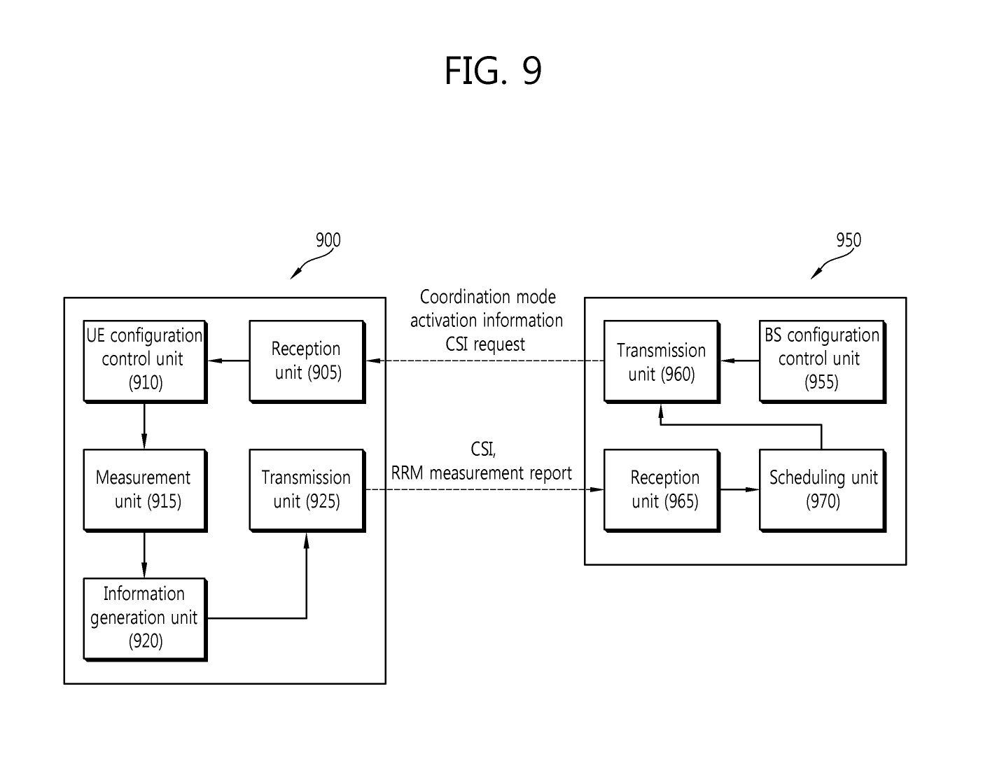

FIG. 9 is a block diagram showing a UE and a BS according to an embodiment of the present invention.

Referring to FIG. 9, the UE 900 includes a reception unit 905, a UE configuration control unit 910, a measurement unit 915, an information generation unit 920, and a transmission unit 925.

The reception unit 905 receives configuration information for an aperiodic CSI report, first subset configuration information for a CSI measurement restriction, second subset configuration information for an RRM/RLM measurement restriction, definition information regarding CSI request information, or RRM measurement configuration information from the BS 950. The reception unit 905 may receive an RRC message, a MAC message, or physical layer signaling from the BS 950. In particular, the reception unit 905 may receive the configuration information for an aperiodic CSI report, the first subset configuration information for a CSI measurement restriction, the second subset configuration information for an RRM/RLM measurement restriction, the definition information regarding CSI request information, or the RRM measurement configuration information through at least one of the RRC message, the MAC message, and the physical layer signaling.

The reception unit 905 further receives coordination mode activation information or CSI request information from the BS 950. The CSI request information may be defined as in, for example, Tables 4 to 7 or Table 9.

The UE configuration control unit 910 configures the UE 900 or changes a previous configuration on the basis of the configuration information for an aperiodic CSI report, the first subset configuration information for a CSI measurement restriction, the second subset configuration information for an RRM/RLM measurement restriction, the definition information regarding CSI request information, or the RRM measurement configuration information. For example, the UE configuration control unit 910 may change the configuration information for an aperiodic CSI report, the subset configuration information, the definition information, or the RRM measurement configuration information. Alternatively, the UE configuration control unit 910 may change all or some of the changes at the same time.

The UE configuration control unit 910 may configure at least one serving cell in the UE 900. Furthermore, the UE configuration control unit 910 performs control on the basis of the indication of the coordination mode activation information so that the state of the UE 900 switches to the ICIC mode.

The measurement unit 915 measures a channel state for a first cell set or a second cell set or both and transmits the result of the measured channel state to the information generation unit 920. In an alternative embodiment, the measurement unit 915 may measure a channel state for a first subset or a second subset or both and transmit the result of the measured channel state to the information generation unit 920. Furthermore, the measurement unit 915 performs RRM/RLM measurement on the basis of the RRM measurement configuration information and transmits the result of the RRM/RLM measurement to the information generation unit 920.

Meanwhile, if the UE 900 is in the ICIC mode, the measurement unit 915 may selectively measure a channel state for each of cell sets according to the state of the serving cell. For example, the measurement unit 915 may measure channel states for serving cells having the first state and may designate default values for serving cells having the second state, but may do not measure channel states for serving cells having the third and the fourth states.

The information generation unit 920 generates CSI about the first or second subset on the basis of the result of the measured channel state and stores the generated CSI in memory or a buffer. Furthermore, the information generation unit 920 provides CSI according to the indication of the CSI request information to the transmission unit 925. For example, the information generation unit 920 may provide only CSI about an activated serving cell within a cell set to the transmission unit 925.

The information generation unit 920 further generates an RRM/RLM measurement report on the basis of the result of the RRM/RLM measurement and stores the generated RRM/RLM measurement report in the memory or the buffer.

The BS 950 includes a BS configuration control unit 955, a transmission unit 960, a reception unit 965, and a scheduling unit 970.

The BS configuration control unit 955 performs a control operation for changing a configuration for the UE 900. For example, the BS configuration control unit 955 may control a procedure of reconfiguring the RRC connection of the UE 900. To this end, the BS configuration control unit 955 may generate an RRC connection reconfiguration message and provide the RRC connection reconfiguration message to the transmission unit 960. Furthermore, the BS configuration control unit 955 generates coordination mode activation information for switching the state of the UE 900 to the ICIC mode and provides the coordination mode activation information to the transmission unit 960.

The transmission unit 960 transmits configuration information for an aperiodic CSI report, first subset configuration information for a CSI measurement restriction, second subset configuration information for an RRM/RLM measurement restriction, definition information regarding CSI request information, or RRM measurement configuration information to the UE 900. The transmission unit 960 may transmit an RRC message, a MAC message, or physical layer signaling to the UE 900. In particular, the transmission unit 960 may transmit the configuration information for an aperiodic CSI report, the first subset configuration information for a CSI measurement restriction, the second subset configuration information for an RRM/RLM measurement restriction, the definition information regarding CSI request information, or the RRM measurement configuration information through at least one of the RRC message, the MAC message, and the physical layer signaling.

The transmission unit 960 further transmits coordination mode activation information or CSI request information to the UE 900.

The reception unit 965 receives an RRC connection reconfiguration completion message and CSI from the UE 900.

The scheduling unit 970 performs scheduling, such as the Modulation and Coding Scheme (MCS) of downlink channels or resource allocation for the UE 900, on the basis of the CSI. If CSI is necessary, the scheduling unit 970 generates an uplink grant (e.g., DCI of a format 0 or a format 4) including CSI request information and transmits the uplink grant to the transmission unit 960.

In the above exemplary systems, although the methods have been described on the basis of the flowcharts using a series of the steps or blocks, the present invention is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and other steps may be included or one or more steps of the flowcharts may be deleted without affecting the scope of the present invention.

The above embodiments include various aspects of examples. Although all possible combinations for describing the various aspects may not be described, those skilled in the art may appreciate that other combinations are possible. Accordingly, the present invention should be construed as including all other replacements, modifications, and changes which fall within the scope of the accompanied claims.

1. A user equipment (UE) transmitting Channel State Information (CSI) in a wireless communication system, the UE comprising:
a reception unit configured for receiving coordination mode activation information indicating an Inter-Cell Interference Coordination (ICIC) mode to restrict a measurement of a channel state, and configured for receiving CSI request information requesting aperiodic transmission of the CSI, from a base station (BS);
a UE configuration control unit configured for switching a state of the UE to the ICIC mode based on the coordination mode activation information and configured for configuring one or more serving cells in the UE;
a measurement unit configured for measuring a channel state for a subset in an activated serving cell from among the configured one or more serving cells based on the CSI request information, the subset being a set of one or more subframes;
an information generation unit configured for generating CSI regarding the measured channel state; and
a transmission unit configured for transmitting the generated CSI to the BS.

2. The UE as claimed in claim 1, wherein the reception unit further receives definition information, defining an indication of the CSI request information, from the BS.

3. The UE as claimed in claim 1, wherein the reception unit further receives subset configuration information for configuring the subset in the UE from the BS.

4. The UE as claimed in claim 1, wherein the measurement unit sets the channel state for a deactivated serving cell from among the one or more serving cells as a preset default value.

5. The UE as claimed in claim 1, wherein the reception unit receives the CSI request information on a Physical Downlink Control CHannel (PDCCH).

6. A method of a user equipment (UE) transmitting Channel State Information (CSI) in a wireless communication system, the method comprising:
receiving coordination mode activation information indicating an Inter-Cell Interference Coordination (ICIC) mode to restrict a measurement of a channel state, from a base station (BS);
switching the UE to the ICIC mode based on the coordination mode activation information;
receiving CSI request information requesting aperiodic transmission of the CSI, from the BS;
measuring, based on the CSI request information, a channel state for a subset in an activated serving cell, from among one or more serving cells configured in the UE, the subset being a set of one or more subframes; and
transmitting the CSI regarding the measured channel state to the BS.

7. The method as claimed in claim 6, further comprising receiving definition information, defining an indication of the CSI request information, from the base station.

8. The method as claimed in claim 6, further comprising receiving subset configuration information for configuring the subset in the UE from the BS.

9. The method as claimed in claim 6, further comprising setting the channel state for a deactivated serving cell from among the one or more serving cells as a preset default value.

10. The method as claimed in claim 6, wherein the CSI request information is received on a Physical Downlink Control CHannel (PDCCH).

11. A base station (BS) receiving Channel State Information (CSI) in a wireless communication system, the BS comprising:
a transmission unit configured for transmitting coordination mode activation information indicating an Inter-Cell Interference Coordination (ICIC) mode to restrict a measurement of a channel state and configured for transmitting CSI request information requesting aperiodic transmission of the CSI to a user equipment (UE);
a reception unit configured for receiving the CSI based on the CSI request information, from the UE; and
a scheduling unit configured for performing downlink scheduling for the UE based on the CSI,
wherein the CSI request information instructs to trigger a report on a channel state restricted by the ICIC mode.

12. The BS as claimed in claim 11, wherein the report on the restricted channel state is a report on a channel state for a subset in an activated serving cell from among one or more serving cells configured in the UE, and wherein the subset is a set of one or more subframes.

13. The BS as claimed in claim 12, wherein the activated serving cell is a primary serving cell for the UE.

14. A method of a base station (BS) receiving Channel State Information (CSI) in a wireless communication system, the method comprising:
transmitting coordination mode activation information, indicating Inter-Cell Interference Coordination (ICIC) mode to restrict a measurement of a channel state, to a user equipment (UE);
transmitting CSI request information, requesting aperiodic transmission of the CSI, to the UE;
receiving the CSI based on the CSI request information, from the UE; and
performing downlink scheduling for the UE based on the CSI, wherein the CSI request information instructs to trigger a report on a channel state restricted by the ICIC mode.

15. The method as claimed in claim 14, wherein the report on the restricted channel state is a report on a channel state for a subset in an activated serving cell from among one or more serving cells configured in the UE, and wherein the subset is a set of one or more subframes.

16. The method as claimed in claim 14, wherein the activated serving cell is a primary serving cell for the UE.
